(19) United States
(12) Patent Application Publication
(10) Pub. No.: US 2023/0061718 A1
(43) Pub. Date: Mar. 2, 2023

(54) PET FEEDER

(71) Applicant: ZHOUCHI XIAO, SHENZHEN (CN)

(72) Inventors: ZHOUCHI XIAO, SHENZHEN (CN); FENG ZHANG, JIAXING (CN)

(21) Appl. No.: 17/663,432

(22) Filed: May 15, 2022

(30) Foreign Application Priority Data
Aug. 25, 2021 (CN) 202122023931.1

(51) Int. Cl. A01K 5/01; A01K 15/02

(52) U.S. Cl. CPC A01K 5/0114; A01K 15/02

(57) ABSTRACT

A pet feeder includes a feeder body. A climbing component is vertically disposed in the feeder body. A climbing portion is disposed on an outer surface of the climbing component. The climbing portion enables the outer surface of the climbing component to be rough. The present disclosure has the advantages that: placing the feeder body in a pet box, placing little reptiles in the feeder body, and the little reptiles are stored in the feeder body, so that probability that the little reptiles crawl around in the pet box is reduced and pet feeding environment is improved. The climbing component is disposed for the little reptiles to crawl, so that activity of the little reptiles is maintained.

### TECHNICAL FIELD

The present disclosure relates to a field of pet supplies, and in particular to a pet feeder.

### BACKGROUND

Pets are creatures that people keep for spiritual purposes rather than for economic purposes. Conventionally, the pets are mammals or birds that are kept for fun and accompanying. In actual life, the pets include fish, reptiles, amphobians, insects, and even plants, and kept for pleasure, accompanying, and reliving mental stress of human beings.

When keeping the pets, it is necessary to regularly provide food. In order to improve an active state of the pets, Little reptiles are usually provided for the reptiles in the pets to feed on. However, directly placing the little reptiles in a pet box may cause the little reptiles to crawl around and affect breeding environment in the pet box.

### SUMMARY

In order to improve pet breeding environment, the present disclosure provides a pet feeder.

The pet feeder provided by the present disclosure includes a feeder body, a climbing component, and a climbing portion. The climbing component extends upwards from the feeder body. The climbing portion, configured for little reptiles to climb along a height direction of the climbing component, is disposed on the climbing component.

Through above technical solution, placing the feeder body in a pet box, and placing little reptiles in the feeder body. The little reptiles are stored in the feeder body, so that probability that the little reptiles crawl around in the pet box is reduced, and the pet breeding environment is improved. The climbing component is provided for the little reptiles to climb, thereby keep activity of the little reptiles.

Optionally, the climbing component is a climbing column, the climbing column is disposed in the feeder body, the climbing portion includes mesh holes circumferentially defined on the climbing column, and a plurality of the mesh holes are defined along the height direction of the climbing component.

Through the above technical solution, the mesh holes enable a surface of the climbing column to be rough, so that the little reptiles conveniently climb through the mesh holes.

Optionally, the climbing component is a climbing column, the climbing column is disposed in the feeder body, and the climbing portion includes spiral blades fixedly disposed on an outer surface of the climbing column.

Through the above technical solution, the spiral blades enable the surface of the climbing column to be rough, so that the little reptiles conveniently climb along the spiral blades.

Optionally, an inserting groove is defined in one end, facing the feeder body, of the climbing component. An inserting ring is fixedly disposed on the feeder body, and the inserting ring is inserted into the inserting groove.

Through the above technical scheme, the inserting groove is matched with the inserting ring to improve mounting strength of the climbing column.

Optionally, the feeder body includes a bottom plate and protective plates, and the protective plates are integrally and circumferentially disposed on the bottom plate.

Through the above technical solution, the protective plates reduce the probability that the little reptiles climb out of the feeder body and crawl around in the pet box.

Optionally, a mounting ring is fixedly disposed at one end, facing the feeder body, of the climbing component. A plurality of mounting components are uniformly and circumferentially disposed on the mounting ring, and the plurality of the mounting components are configured to be fixedly connected with the feeder body.

Through the above technical solution, the mounting ring is provided to match with the mounting components, so that the mounting strength of the climbing column is further improved.

Optionally, the climbing component is a climbing plate, and the climbing plate is disposed on the protective plates. The climbing portion includes mesh holes defined on the climbing plate, or climbing strips fixedly disposed on the climbing plate and extending upwards from a bottom of the climbing plate.

Through the above technical solution, the mesh holes defined on the climbing plate, or the climbing strips fixedly disposed on the climbing plate, enable a surface of the climbing plate to be rough, so that the little reptiles conveniently climb through the mesh holes or the climbing strips.

Optionally, a fixing hook is disposed at one end, facing away from the feeder body, of the climbing component.

Through the above technical solution, the fixing hook enables the pet feeder to be hung in the pet box, which facilitates installation and placement of the pet feeder in the pet box.

Optionally, a plurality of reinforcing assemblies are disposed in the feeder body, the plurality of the reinforcing assemblies are disposed corresponding to the plurality of the mounting components. Each of the plurality of the reinforcing assemblies includes a reinforcing groove, a reinforcing block, and a reinforcing spring. The reinforcing groove is defined on the feeder body and further defined perpendicular to each of the plurality of the mounting components. The reinforcing block is slidably disposed in the reinforcing groove and abuts against a side wall of each of the plurality of the mounting components. The reinforcing block slides towards or away from each of the plurality of the mounting components. The reinforcing spring is disposed in the reinforcing groove. A first end of the reinforcing spring is fixedly disposed at a bottom of the reinforcing groove. A second end of the reinforcing spring is fixedly disposed at one end, facing away from each of the mounting components, of the reinforcing block. The reinforcing spring drives the reinforcing block to slide towards each of the mounting components.

Through the above technical solution, an arrangement of the plurality of the reinforcing assemblies increases fixing strength of the climbing component in the feeder body.

Optionally, a through hole is defined in a center of the climbing component in the feeder body. Each of the plurality of the reinforcing assemblies is disposed on one side, facing the through hole, of the respective one of the mounting components. A pull rod is fixedly disposed at one end, facing the through hole, of the reinforcing block. The pull rod penetrates through the feeder body and extends into the through hole.

Through the above technical solution, the pull rod is matched with the through hole, which conveniently drives the reinforcing block to slide in a direction distal from the mounting components, and facilitates disassembly of the mounting components.

Based on above, the present disclosure includes at least one of following beneficial technical effects:

The feeder body is placed in the pet box, and then the little reptiles are put in the feeder body. The little reptiles are stored in the feeder body, so that the probability that the little reptiles crawl around in the pet box is reduced, and the pet breeding environment is improved. The climbing component is provided for the little reptiles to climb, thereby keeping activity of the little reptiles. The inserting groove is matched with the inserting ring to improve the mounting strength of the climbing column. The mounting ring is provided to match with the mounting components, so that the mounting strength of the climbing column is further improved. The arrangement of the plurality of the reinforcing assemblies increases the fixing strength of the climbing component in the feeder body. The pull rod is matched with the through hole, which conveniently drives the reinforcing block to slide in the direction distal from the mounting components, and facilitates the disassembly of the mounting components. Ropes are mutually tied together to conveniently drive all the pull rods at the same time.

### BRIEF DESCRIPTION OF DRAWINGS

FIG. 1 is an overall structural schematic diagram of a pet feeder according to embodiment one of the present disclosure.

FIG. 2 is a cross-sectional structural schematic diagram of the pet feeder according to embodiment one of the present disclosure.

FIG. 3 is a cross-sectional structural schematic diagram of the pet feeder according to embodiment two of the present disclosure.

FIG. 4 is an overall structural schematic diagram of the pet feeder according to embodiment three of the present disclosure.

FIG. 5 is an overall structural schematic diagram of the pet feeder according to embodiment four of the present disclosure.

FIG. 6 is an overall structural schematic diagram of the pet feeder according to embodiment five of the present disclosure.

FIG. 7 is an enlarged schematic diagram of portion A shown in FIG. 6.

Description of reference numbers: 1. feeder body; 101. bottom plate; 102. protective plates; 2. climbing component; 201. climbing column; 202. climbing plate; 3. climbing portion; 301. mesh holes; 302. spiral blades; 4. inserting groove; 5. inserting ring; 6. mounting ring; 7. mounting components; 71. mounting bolts; 72. bolts; 8. reinforcing assemblies; 81. reinforcing groove; 82. reinforcing block; 83. reinforcing spring; 9. chamfer; 10. through hole; 11. pull rod; 12. ropes; 13. mounting table; 14. fixing hook; and 15. jacks.

### DETAILED DESCRIPTION

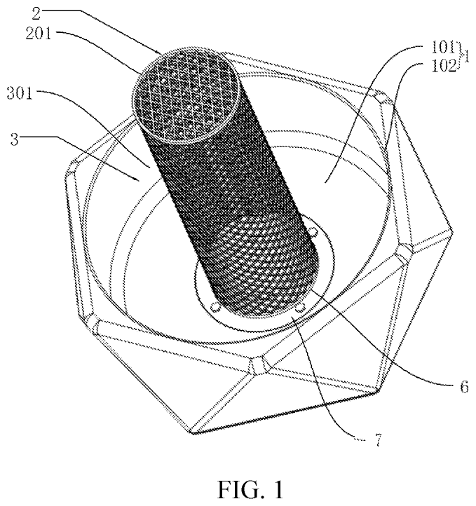

The present disclosure is further described in details below with reference to FIGS. 1-8.

Embodiment One

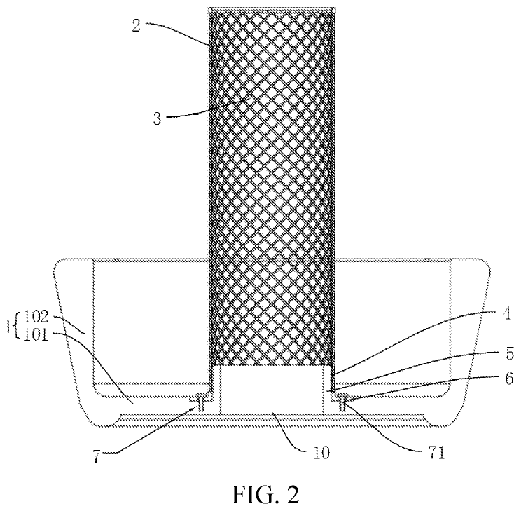

The embodiment one of the present disclosure provides a pet feeder. Referring to FIGS. 1 and 2, the pet feeder includes a feeder body 1. The feeder body 1 includes a bottom plate 101 and protective plates 102, and the protective plates 102 are integrally and circumferentially disposed on the bottom plate 101. Shapes of the protective plates 102 are not limited herewith, and the protective plates 102 are configured to limit little reptiles to climb anywhere and reduce probability of the little reptiles crawl out of the feeder body 1. A climbing component 2 is detachably disposed in a center of the feeder body 1. A climbing portion 3 is disposed on an outer surface of the climbing component 2. The climbing portion 3 enables the outer surface of the climbing component 2 to be rough, and the climbing portion 3 is configured for the little reptiles to climb along a height direction of the climbing component 2, which is convenient for the little reptiles to crawl. The feeder body 1 is placed in the pet box, and then the little reptiles are put in the feeder body 1. The little reptiles are stored in the feeder body 1, so that the probability that the little reptiles crawl around in the pet box is reduced, and the pet breeding environment is improved. The climbing component 2 is provided for the little reptiles to climb, thereby keeping activity of the little reptiles.

Referring to FIGS. 1 and 2, the climbing component 2 is a climbing column 201, and the climbing column 201 is disposed on the bottom plate 101. The climbing portion 3 includes mesh holes 301 circumferentially defined on the climbing column 201. A circular through hole 10 is defined on the bottom plate 101 of the feeder body 1, and the circular through hole 10 is defined in a middle of the climbing column 201. An inserting ring 5 is integrally disposed on the feeder body 1. An inserting groove 4 is defined in one end, facing the feeder body 1, of the climbing column 201. An inner side wall of the climbing column 201 fits on an outer side wall of the inserting ring 5 and the inserting ring 5 is inserted into the inserting groove 4. The inserting ring 5 and the inserting groove 4 are matched to increase connection strength of the climbing column 201.

Referring to FIGS. 1-2, a mounting ring 6 is fixedly disposed at one end, facing the feeder body 1, of the climbing column 201. An embedding groove, corresponding to the mounting ring 6, is defined on the feeder body 1. The mounting ring 6 is embedded in the feeder body 1 through the embedding groove. When the mounting ring 6 is embedded in the feeder body 1, an upper end of the mounting ring 6 is flush with the bottom plate 101 of the feeder body 1, which reduces effects where protrusions affect crawling of the little reptiles. Four mounting components 7 are uniformly and circumferentially disposed on the mounting ring 6. The mounting ring 6 is detachably disposed on the feeder body 1 through the mounting components 7. The mounting ring 6 is provided to match with the mounting components 7 to further improve mounting strength of the climbing column 201. The mounting components 7 include mounting bolts 71. Rod bodies of the mounting bolts 71 penetrate the mounting ring 6 and are threadedly connected to the feeder body 1. The mounting ring 6 is fixedly disposed on the feeder body 1 through the mounting bolts 71 to realize detachable installation of the climbing column 201.

Implementation principle of the embodiment one of the present disclosure is as follows: installing the climbing column 201 on the feeder body 1, inserting the mounting bolts 71 through the mounting ring 6, screwing the mounting bolts 71 on the feeder body 1, and placing the feeder body 1 in the pet box for feeding the pets.

Embodiment Two

The embodiment two of the present disclosure provides a pet feeder, which is different from the embodiment one in a feature of climbing portion 3.

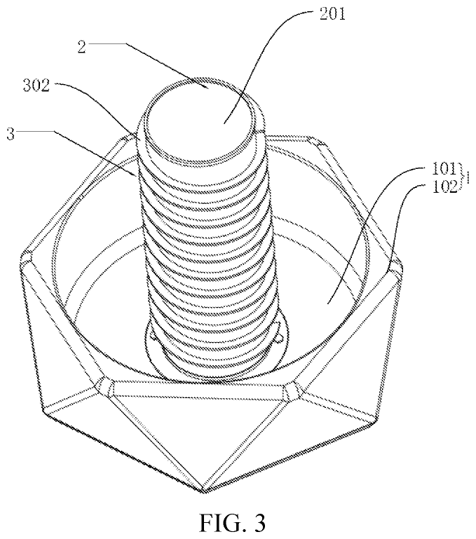

Referring to FIG. 3, the climbing portion 3 includes spiral blades 302 fixedly disposed on an outer surface of the climbing column 201. The spiral blades 302 enable a surface of the climbing column 201 to be rough, which is convenient for the little reptiles climb.

Embodiment Three

The embodiment three of the present disclosure provides a pet feeder, which is different from the embodiment 1 in features of climbing component 2 and climbing portion 3.

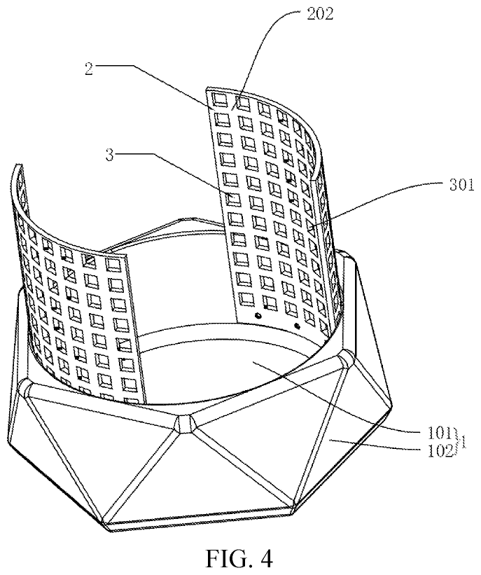

Referring to FIG. 4, the climbing component 2 is a climbing plate 202. The climbing plate 202 is vertically and detachably disposed on the protective plates 102. The climbing portion 3 includes mesh holes 301 defined on the climbing plate 202. Smooth plate body is not easy for the little reptiles to crawl, and the mesh holes 301 are defined on the climbing plate 202 to enable a surface of the climbing plate 202 to be rough, so as to be convenient for the little reptiles to climb.

The implementation principle of the embodiment three of the present disclosure is as follows: installing the climbing plate 202 on the feeder body 1, and then placing the feeder body 1 in the pet box for feeding the pets.

Embodiment Four

The embodiment four of the present disclosure provides a pet feeder, which is different from the embodiment one in the feature that a fixing hook 14 is disposed on a climbing column 201.

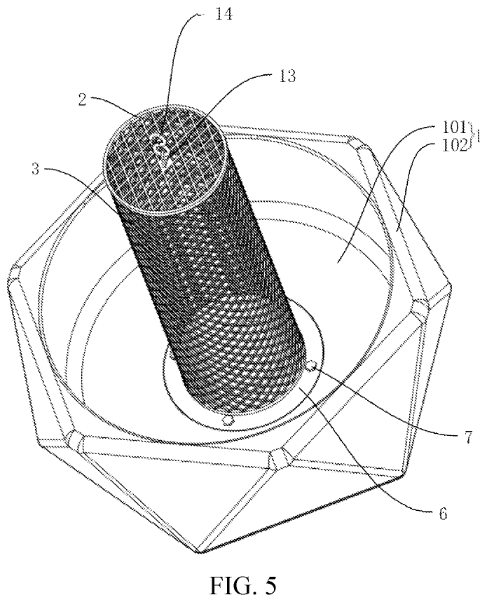

Referring to FIG. 5, a mounting table 13 is fixedly disposed at a top of the climbing column 201. The fixing hook 14 is disposed on the mounting table 13. The fixing hook 14 is provided to enable the feeder body 1 to be hung, which facilitates installation of the feeder body 1.

The implementation principle of the embodiment four of the present disclosure is as follows: installing the climbing column 201 on the feeder body 1, and inserting the mounting bolts 71 through the mounting ring 6, and screwing the mounting bolts 71 on the feeder body 1. During the process, the mounting bolts 71 abut against a chamfer 9 and drive a reinforcing block 82 to slide toward a reinforcing groove 81. After the mounting bolts 71 is installed, the reinforcing block 82 abuts on a side wall of the mounting bolts 71 to reinforce the mounting bolts 71. Afterwards, placing the feeder body 1 in the pet box or hanging the feed body 1 in the pet box for feeding the pets.

Embodiment Five

The embodiment five of the present disclosure provides a pet feeder, which is different from the embodiment one in the feature of mounting components 7.

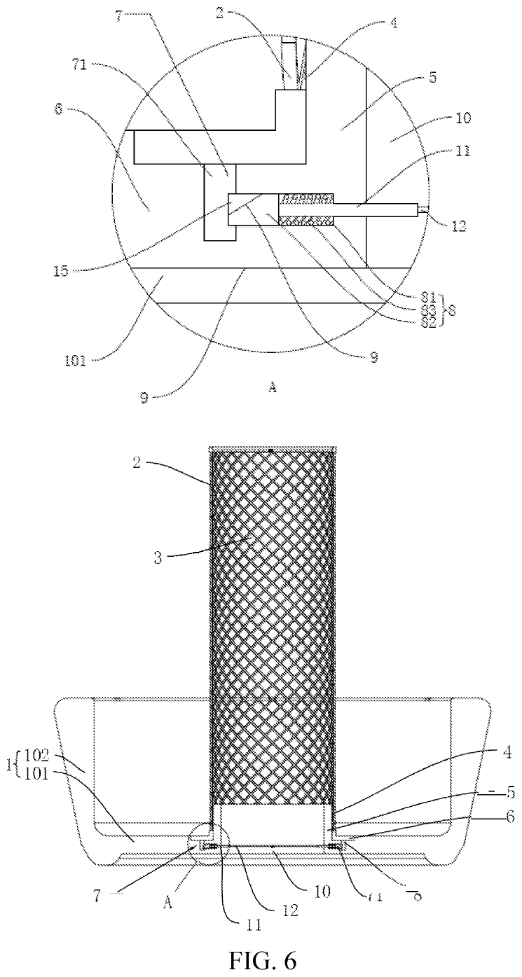

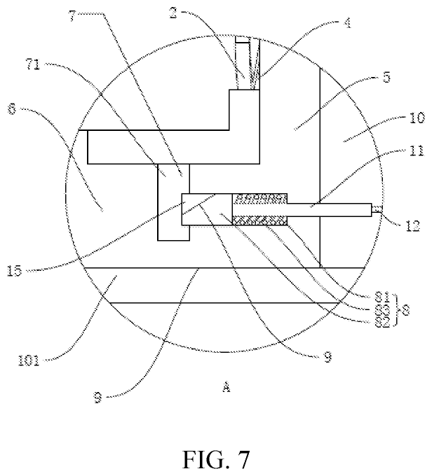

Referring to FIGS. 6-7, the mounting components 7 include bolts 72, and the bolts 72 penetrate through the mounting ring 6. The bolts 72 are disposed on one side, facing the feeder body 1, of the mounting ring 6. The bolts 72 are inserted into the feeder body 1 at one side, facing the feeder body 1, of the mounting ring 6. Jacks 15 are defined on a side wall of the bolts 72. When the bolts 72 are inserted into the feeder body 1, the reinforcing block 82 is inserted into the jacks 15, and the mounting ring 6 is fixedly disposed on the feeder body 1 through the bolts 72 to realize detachable installation of the climbing column 201.

Referring to FIGS. 6-7, a plurality of reinforcing assemblies 8 are disposed in the feeder body 1. There are four sets of reinforcing assemblies 8. The four sets of the reinforcing assemblies 8 are disposed corresponding to the four sets of the mounting components 7. The reinforcing assemblies 8 are disposed at one end, facing a center of the feeder body 1, of the mounting components 7. Each of the reinforcing assemblies 8 includes a reinforcing groove 81, a reinforcing block 82, and a reinforcing spring 83. The reinforcing groove 81 is horizontally defined on the feeder body 1 and further defined perpendicular to each of the plurality of the mounting components 7. The reinforcing block 82 is slidably disposed in the reinforcing groove 81 and abuts against a side wall of each of the plurality of the mounting components 7. The reinforcing block 82 slides towards or away from each of the plurality of the mounting components 7. The reinforcing spring 83 is disposed in the reinforcing groove 81. A first end of the reinforcing spring 83 is fixedly disposed at a bottom of the reinforcing groove 81, and a second end of the reinforcing spring 83 is fixedly disposed at one end, facing away from each of the mounting components 7, of the reinforcing block 82. The reinforcing spring 83 drives the reinforcing block 82 to slide towards each of the mounting components 7. The reinforcing block 82 is driven to abut on the mounting components 7 through elastic force of the reinforcing spring 83, and probability that the mounting components 7 are disengaged from the feeder body 1 is reduced through friction force of the reinforcing block 82 abutting on the mounting components 7. A chamfer 9 is defined at one end, facing each of the mounting components 7, of the reinforcing block 82. The chamfer 9 is defined at one end, facing each of the mounting components 7 and entering the feeder body 1, of the reinforcing block 82. When the mounting components 7 enter the feeder body 1, the chamfer 9 drives the reinforcing block 82 to enter the reinforcing groove 81 through abutting the chamfer 9, which facilitates mounting of the mounting components 7.

Referring to FIGS. 6-7, each of the plurality of the reinforcing assemblies 8 is disposed on one end, facing the center of the feeder body 1, of the respective one of the mounting components 7. A pull rod 11 is fixedly disposed at one end, facing a through hole 10, of the reinforcing block 82. The pull rod 11 penetrates through the feeder body 1 and extends into the through hole 10. The reinforcing spring 83 is sleeved on an outer side of the pull rod 11, the pull rod 11 is pulled to slide the reinforcing block 82 in the reinforcing groove 81, and at this time, the mounting components 7 are detached normally. Ropes 12 are disposed on one end, extending into the through hole 10, of the pull rod 11. An end, facing away from a plurality of the pull rods 11, of each of the ropes 12 on the plurality of pull rods 11 are tied to each other, and the ropes 12 are tied together to facilitate simultaneous driving of all the pull rods 11.

The implementation principle of the embodiment five of the present disclosure is follows: installing the climbing column 201 on the feeder body 1, and then inserting the bolts 72 into the feeder body 1. During the process, the bolts 72 abut against the chamfer 9 and drive the reinforcing block 82 to slide toward the reinforcing groove 81. After the bolts 72 are installed, the reinforcing block 82 abuts against the jacks 15 of the bolts 72 to fix and reinforce the bolts 72. Afterwards, placing the feeder body 1 in the pet box for feeding the pets.

It should be noted that the pets in the embodiments of the present disclosure include chameleons or other reptiles. The chameleons and other reptiles see little reptiles and may start predation when people fill the little reptiles in a feeder of the pet feeder, such as the climbing component, and the little reptiles may climb on the climbing portion, such as the mesh holes. Thereby, the chameleons and other reptiles (especially inactive animals) actually work for their food. People further use a product such as calcium powder to dust the little reptiles if the little reptiles are still on a bottom of the feeder body, such as a feeding bowl, and before the little reptiles climb on the climbing portion, such as the mesh holes. The pet feeder is further provided with a drainage hole to be beneficial for people to using the pet feeder in a glass container having an atomization system. It should be understood that the pets further include other types of animals, and the embodiments of the present disclosure do not define type of the pets.

In wild, the chameleons and other reptiles feed on little reptiles in a wide variety, acute dynamic vision keeps the chameleons and other reptiles ignoring those inactive little reptiles, such as Dubia cockroach. The pet feeder solves the maximum problem for the chameleons and other reptiles. The pet feeder is bright green or other colors, which helps the chameleons and other reptiles to clearly see the little reptiles in the pet feeder. The pet feeder has a vertical climbing component, a plurality of the mesh holes are defined on the climbing component for the insects to climb on. The pet feeder further includes an iron hanging chain and an umbrella-shaped iron cover, and the umbrella-shaped iron cover covers the feeder body and the climbing component to prevent the insects from climbing up the chain to escape. The hanging chain is disposed on the umbrella-shaped iron cover, so that the umbrella-shaped iron cover is convenient to move.

All the above are the preferred embodiments of the present disclosure, and protection scope of the present disclosure is not limited thereto. Therefore, equivalent changes made according to structure, shape and principle of the present disclosure shall fall within the protection scope of the present disclosure.

What is claimed is:

1. A pet feeder, comprising:
a feeder body;
a climbing component; and
a climbing portion;
wherein the climbing component extends upwards from the feeder body, and the climbing portion, configured for little reptiles to climb along a height direction of the climbing component, is disposed on the climbing component;
wherein a mounting ring is fixedly disposed at one end, facing the feeder body, of the climbing component; a plurality of mounting components are uniformly and circumferentially disposed on the mounting ring, and the plurality of the mounting components are configured to be fixedly connected with the feeder body;
wherein the plurality of reinforcing assemblies are disposed in the feeder body, the plurality of the reinforcing assemblies are disposed corresponding to the plurality of the mounting components, each of the plurality of the reinforcing assemblies comprises a reinforcing groove, a reinforcing block, and a reinforcing spring; the reinforcing groove is defined on the feeder body and further defined perpendicular to each of the plurality of the mounting components, the reinforcing block is slidably disposed in the reinforcing groove and abuts against a side wall of each of the plurality of the mounting components, the reinforcing block slides towards or away from each of the plurality of the mounting components, the reinforcing spring is disposed in the reinforcing groove; a first end of the reinforcing spring is fixedly disposed at a bottom of the reinforcing groove, a second end of the reinforcing spring is fixedly disposed at one end, facing away from each of the mounting components, of the reinforcing block; and the reinforcing spring drives the reinforcing block to slide towards each of the mounting components.

2. The pet feeder according to claim 1, wherein the climbing component is a climbing column, the climbing column is disposed in the feeder body, the climbing portion comprises mesh holes circumferentially defined on the climbing column, and a plurality of the mesh holes are defined along the height direction of the climbing component.

3. (canceled)

4. The pet feeder according to claim 1, wherein an inserting groove is defined in one end, facing the feeder body, of the climbing component; an inserting ring is fixedly disposed on the feeder body, and the inserting ring is inserted into the inserting groove.

5. The pet feeder according to claim 1, wherein the feeder body comprises a bottom plate and protective plates, and the protective plates are integrally and circumferentially disposed on the bottom plate.

6. (canceled)

7. (canceled)

8. The pet feeder according to claim 1, wherein a fixing hook is disposed at one end, facing away from the feeder body, of the climbing component.

9. (canceled)

10. The pet feeder according to claim 1, the through hole is defined in a center of the climbing component in the feeder body, each of the plurality of the reinforcing assemblies is disposed on one side, facing the through hole, of the respective one of the mounting components, a pull rod is fixedly disposed at one end, facing the through hole, of the reinforcing block, and the pull rod penetrates through the feeder body and extends into the through hole.
